(19) United States
(12) Patent Application Publication
(10) Pub. No.: US 2010/0035652 A1
(43) Pub. Date: Feb. 11, 2010

(54) MOBILE PHONE AND METHOD FOR SEARCHING A PHONEBOOK IN A LOW POWER STATE

(75) Inventor: KUO-JUI WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/479,830

(22) Filed: Jun. 7, 2009

(30) Foreign Application Priority Data
Aug. 11, 2008 (CN) 200810303643.8

(51) Int. Cl. H04M 1/00

(52) U.S. Cl. 455/558; 455/574

(57) ABSTRACT

A mobile phone and method for searching a phonebook of the mobile phone are provided. The method can search the phonebook of the mobile phone when the mobile phone is in a low power state. The method defines a first predefined voltage and a second predefined voltage for the mobile phone when the mobile phone is powered on. The method further measuring a battery voltage of the mobile phone, and controls the mobile phone to work in a phonebook mode if the battery voltage is less than the first predefined voltage. In addition, the method generates a phonebook search interface when the mobile phone works in the phonebook mode, and searches a phonebook according to search conditions input from the phonebook search interface.

### BACKGROUND

1. Technical Field

Embodiments of the present disclosure relate to systems and methods for searching a phonebook of a mobile phone, and more particularly to a mobile phone and method for searching a phonebook in a low power state.

2. Description of Related Art

A common feature of a mobile phone is to include an electronic phonebook or database which contains a list of phonebook items. Each item may include phone numbers and information details, such as names and addresses associated with the phone numbers. When a user of the mobile phone wishes to make a telephone call or search for desired information, such as the phone numbers, the addresses or the like, the user can search the phonebook to obtain the desired information by operation of the mobile telephone. However, in the case that a battery voltage of the mobile phone has low power, and the battery cannot be charged, problems may arise when searching for desired information of the phonebook.

Therefore, there is an improved system and method for searching a phonebook of a mobile phone, which can search the phonebook of the mobile phone when the mobile phone is in a low power state.

### BRIEF DESCRIPTION OF THE DRAWINGS

FIG. 1 is a schematic diagram of one embodiment of a mobile phone for searching a phonebook in a low power state.

FIG. 2 is a flowchart of one embodiment of a method for searching a phonebook of a mobile phone in a low power state.

### DETAILED DESCRIPTION

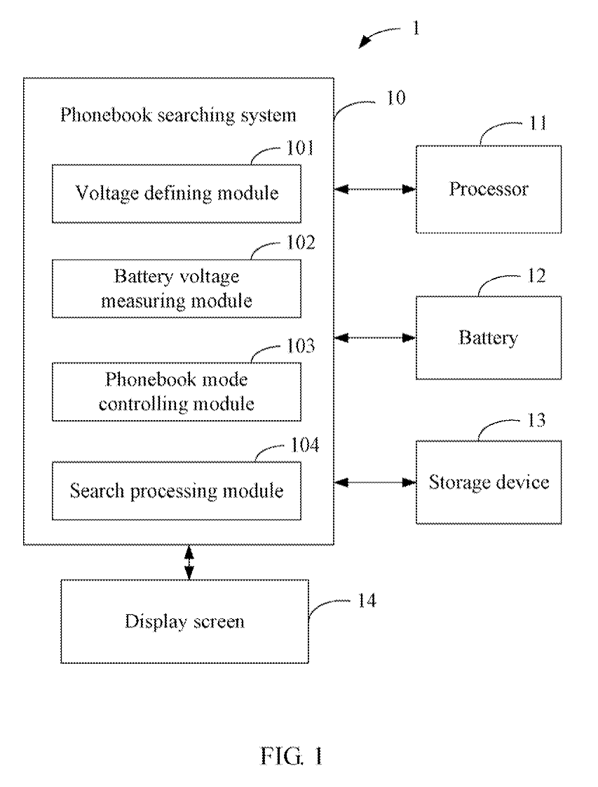

FIG. 1 is a schematic diagram of one embodiment of a mobile phone 1 for searching a phonebook in a low power state. The mobile phone 1 includes a phonebook searching system 10, which is used to search phonebook information of the mobile phone 1 when the mobile phone 1 is in the low power state. For example, the mobile phone 1 is in the low power state upon condition that a current battery voltage of the mobile phone 1 is less than a normal working power. The mobile phone 1 may include at least one processor 11 that executes computerized codes for the phonebook searching system 10, and may further include a battery 12, a storage device 13, and a display screen 14. In one embodiment, the phonebook searching system 10 is included in the storage device 13 or a computerized readable medium of the mobile phone 1. In another embodiment, the phonebook searching system 10 may be included in an operating system of the mobile phone 1.

The battery 12 provides a battery voltage for the mobile phone 1. In one embodiment, the battery 12 may be a lithium battery, a nickel battery, or any other power source for the mobile phone 1.

The storage device 13 stores an electronic phonebook which contains a list of phonebook items. Each item may include phone numbers and contact details, such as names and addresses. In one embodiment, the storage device 13 may be a smart media card, a secure digital card, a compact flash card, a multi media card, or extreme digital card, for example.

The display screen 14 is operable to display a phonebook search interface generated by the phonebook searching system 10, and to display searched results, such as the phone numbers, the addresses or the like. The phonebook search interface is used to receive search conditions for searching the phonebook of the mobile phone 1, so as to obtain the search results, if any. After the search conditions are inputted through the phonebook search interface, the searched results are displayed on the display screen 14.

In one embodiment, the phonebook searching system 10 may include a voltage defining module 101, a battery voltage measuring module 102, a phonebook mode controlling module 103, and a search processing module 104. Each of the function modules 101-104 can be executed by the at least one processor 11 of the mobile phone 1.

The voltage defining module 101 is operable to define a first predefined voltage and a second predefined voltage for the mobile phone 1 when the mobile phone 1 is powered on. In one embodiment, the first predefined voltage is greater than the second predefined voltage. For example, the first predefined voltage can be set as 3.0 volts, and the second predefined voltage can be set as 2.5 volts. The mobile phone 1 can be automatically switched to an energy saving state when the battery voltage of the mobile phone 1 is less than 3.0 volts, and automatically powered off when the battery voltage is less than 2.5 volts.

The battery voltage measuring module 102 is operable to measure the battery voltage of the mobile phone 1 periodically, and determine whether the battery voltage is less than the first predefined voltage or less than the second predefined voltage.

The phonebook mode controlling module 103 is operable to control the mobile phone 1 to be in a phonebook mode when the battery voltage is less than the first predefined voltage. In the phonebook mode, the mobile telephone is in the energy saving state, and additional functions other than searching the phonebook of the mobile phone 1 are disabled. The additional functions may include a network searching function, a wireless transmission function, an audio/video playing function, a keypad backlight function, for example.

The search processing module 104 is operable to generate a phonebook search interface when the mobile phone 1 is in the phonebook mode, search the phonebook according to the search conditions from the phonebook search interface, and display the searched results on the display screen 14. In addition, the search processing module 104 is operable to terminate the phonebook search interface and power off the mobile phone 1 when the battery voltage is less than the second predefined voltage.

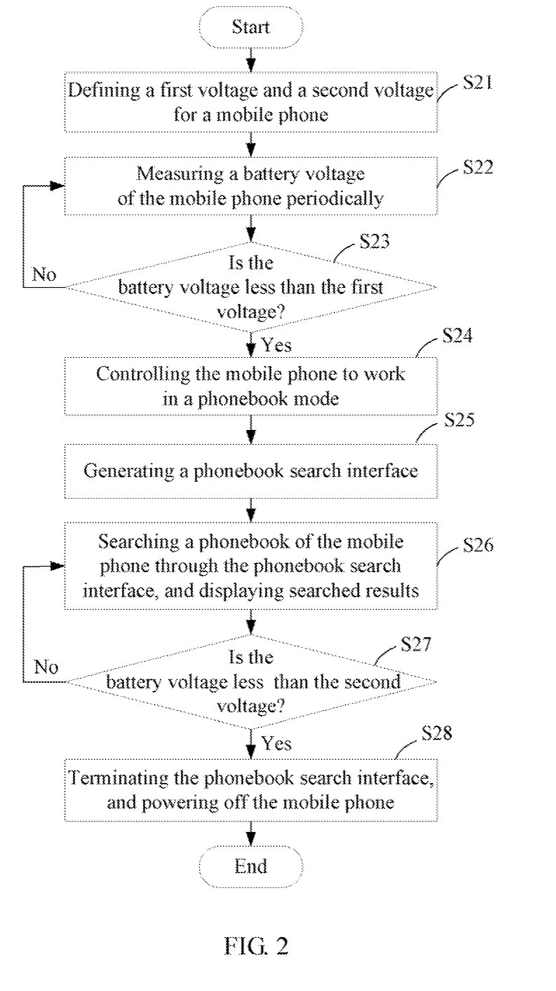

FIG. 2 is a flowchart of one embodiment of a method for searching a phonebook of a mobile phone in a low power state by using the system 10 of FIG. 1 as described above. Depending on the embodiment, additional blocks may be added, others removed, and the ordering of the blocks may be changed.

In block S21, the voltage defining module 101 defines a first predefined voltage and a second predefined voltage for the mobile phone 1 when the mobile phone 1 is powered on. In one embodiment, the first predefined voltage is greater than the second predefined voltage. For example, the first predefined voltage can be set as 3.0 volts, and the second predefined voltage can be set as 2.5 volts.

In block S22, the battery voltage measuring module 102 measures a battery voltage of the mobile phone 1 periodically. In block S23, the battery voltage measuring module 102 determines whether the battery voltage is less than the first predefined voltage (i.e., 3.0 volt). If the battery voltage is not less than the first predefined voltage, the procedure returns to block S22 as described above.

Otherwise, if the battery voltage is less than the first predefined voltage, in block S24, the phonebook mode controlling module 103 controls the mobile phone 1 to work in a phonebook mode. Under the phonebook mode, the mobile telephone works in the energy saving state, and additional functions other than searching the phonebook of the mobile phone 1 are disabled. The additional functions may include a network searching function, a wireless transmission function, an audio/video playing function, a keypad backlight function, for example.

In block S25, the search processing module 104 generates a phonebook search interface when the mobile phone 1 works in the phonebook mode. The phonebook search interface is used to receive search conditions for searching the phonebook of the mobile phone 1, so as to obtain the searched results.

In block S26, the search processing module 104 searches the phonebook stored in the storage device 13 according to search conditions from the phonebook search interface, and displays the searched results on the display screen 14. For example, a user of the mobile phone 1 inputs the search conditions through the phonebook search interface, then the searched results, such as phone numbers, addresses or the like, are displayed on the display screen 14.

In block S27, the battery voltage measuring module 102 determines whether the battery voltage is less than the second predefined voltage (i.e., 2.5 volt). If the battery voltage is not less than the second predefined voltage, the procedure returns to block S26 as described above. Otherwise, if the battery voltage is less than the second predefined voltage, in block S28, the search processing module 104 terminates the phonebook search interface and powers off the mobile phone 1.

All of the processes described above may be embodied in, and fully automated via, functional code modules executed by one or more general purpose processors of electronic devices having an electronic phonebook or database. The functional code modules may be stored in any type of readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone for searching a phonebook of the mobile phone in a low power state, the mobile phone comprising:
a storage device operable to store a phonebook searching system and a phonebook; and
at least one processor operable to execute the phonebook searching system, the phonebook searching system comprising:
a voltage defining module operable to define a first predefined voltage and a second predefined voltage for the mobile phone when the mobile phone is powered on, wherein the first predefined voltage is greater than the second predefined voltage;
a battery voltage measuring module operable to measure a battery voltage of the mobile phone periodically, determine whether the battery voltage is less than the first predefined voltage or less than the second predefined voltage;
a phonebook mode controlling module operable to control the mobile phone to work in a phonebook mode when the battery voltage is less than the first predefined voltage; and
a search processing module operable to generate a phonebook search interface when the mobile phone works in the phonebook mode, search the phonebook from the storage device according to search conditions from the phonebook search interface, and display searched results on a display screen of the mobile phone.

2. The mobile phone according to claim 1, wherein the search processing module is further operable to terminate the phonebook search interface and power off the mobile phone when the battery voltage is less than the second predefined voltage.

3. The mobile phone according to claim 1, wherein the phonebook mode controlling module is further operable to switch the mobile telephone to an energy saving state, and disable additional functions of the mobile phone other than searching the phonebook.

4. The mobile phone according to claim 3, wherein the additional functions comprise a network searching function, a wireless transmission function, an audio/video playing function, and a keypad backlight function.

5. The mobile phone according to claim 1, wherein the storage device is selected from the group consisting of a smart media card, a secure digital card, a compact flash card, a multi media card, and an extreme digital card.

6. A method for searching a phonebook of a mobile phone in a low power state, the method comprising:
defining a first predefined voltage and a second predefined voltage for the mobile phone when the mobile phone is powered on, wherein the first predefined voltage is greater than the second predefined voltage;
measuring a battery voltage of the mobile phone periodically;
determining whether the battery voltage is less than the first predefined voltage;
controlling the mobile phone to work in a phonebook mode if the battery voltage is less than the first predefined voltage;
generating a phonebook search interface;
searching a phonebook stored in a storage device of the mobile phone according to search conditions from the phonebook search interface; and
displaying searched results on a display screen of the mobile phone.

7. The method according to claim 6, further comprising:
terminating the phonebook search interface and powering off the mobile phone, if the battery voltage is less than the second predefined voltage.

8. The method according to claim 6, wherein the phonebook mode means that the mobile telephone is in an energy saving state and additional functions other than searching the phonebook are disabled.

9. The method according to claim 8, wherein the additional functions comprise a network searching function, a wireless transmission function, an audio/video playing function, and a keypad backlight function.

10. The method according to claim 6, wherein the storage device is selected from the group consisting of a smart media card, a secure digital card, a compact flash card, a multi media card, and an extreme digital card.

11. A readable medium having stored thereon instructions that, when executed by a mobile phone, cause the mobile phone to perform a method for searching a phonebook in a low power state, the method comprising:
defining a first predefined voltage and a second predefined voltage for the mobile phone when the mobile phone is powered on, wherein the first predefined voltage is greater than the second predefined voltage;
measuring a battery voltage of the mobile phone periodically;
determining whether the battery voltage is less than the first predefined voltage;
controlling the mobile phone to work in a phonebook mode if the battery voltage is less than the first predefined voltage;
generating a phonebook search interface;
searching a phonebook stored in a storage device of the mobile phone according to search conditions from the phonebook search interface; and
displaying searched results on a display screen of the mobile phone.

12. The medium according to claim 11, wherein the method further comprises:
terminating the phonebook search interface and powering off the mobile phone, if the battery voltage is less than the second predefined voltage.

13. The medium according to claim 11, wherein the phonebook mode means that the mobile telephone is in an energy saving state and additional functions other than searching the phonebook are disabled.

14. The medium according to claim 13, wherein the additional functions comprise a network searching function, a wireless transmission function, an audio/video playing function, and a keypad backlight function.

15. The medium according to claim 11, wherein the storage device is selected from the group consisting of a smart media card, a secure digital card, a compact flash card, a multi media card, and an extreme digital card.
